(19) United States
(12) Patent Application Publication
(10) Pub. No.: US 2013/0151374 A1
(43) Pub. Date: Jun. 13, 2013

(54) Social Marketplace Platform

(71) Applicant: Cox Digital Exchange, LLC, Atlanta, GA (US)

(72) Inventors: Paul David Sims, Alpharetta, GA (US); Gregory Claud Easterly, Atlanta, GA (US); Stanley Cooper Green, Jr., Atlanta, GA (US)

(73) Assignee: COX DIGITAL EXCHANGE, LLC, Atlanta, GA (US)

(21) Appl. No.: 13/682,546

(22) Filed: Nov. 20, 2012

Related U.S. Application Data
(60) Provisional application No. 61/563,210, filed on Nov. 23, 2011.

(51) Int. Cl. G06Q 30/06

(52) U.S. Cl. CPC G06Q 30/0609
USPC 705/26.35

(57) ABSTRACT

A dealer-to-dealer social marketplace platform for aggregating item inventories and providing the items to potential buyers, sellers, dealers, traders, wholesalers, and/or retailers is provided. Dealers, buyers, and/or other users of the platform may create groups of other platform users to facilitate social and/or trusted networks for viewing and/or exchanging items listed in a seller's inventory.

### CROSS-REFERENCE TO RELATED APPLICATIONS

This application claims the benefit of and priority to U.S. Provisional Patent Application No. 61/563,210, entitled “Social Marketplace Platform,” filed Nov. 23, 2011, which is hereby incorporated by reference in its entirety.

### BRIEF DESCRIPTION OF THE DRAWINGS

The detailed description is set forth with reference to the accompanying drawings, which are not necessarily drawn to scale. In the figures, the left-most digit(s) of a reference number identifies the figure in which the reference number first appears. The same reference numbers in different figures indicate similar or identical items.

FIG. 1 depicts an illustrative architecture in which techniques for a dealer-to-dealer social marketplace platform may be implemented.

FIG. 2 depicts an illustrative architecture in which additional techniques for facilitating a social marketplace platform may be implemented.

FIG. 3 illustrates an example flow diagram showing processes for providing a dealer-to-dealer social marketplace.

FIG. 4 illustrates an example flow diagram showing processes for providing a dealer-to-dealer social marketplace.

### DETAILED DESCRIPTION

### Overview

Embodiments of the present disclosure are directed to, among other things, providing a dealer-to-dealer social marketplace platform for aggregating item inventories and providing the items to potential buyers, sellers, dealers, traders, wholesalers, and/or retailers. Additionally, dealers, buyers, and/or other users of the platform may create groups of other platform users to facilitate social and/or trusted networks for viewing and/or exchanging items listed in a seller's inventory. For example, one or more item inventories (each, possibly, from a different seller) may be received, scrubbed, indexed, or otherwise aggregated into a marketplace record of items and presented to buyers based on being associated with one or more buyer-defined groups. In some aspects, the buyers may view the items by way of a list, a grouping, an index, or other data structure presented on a display device of a buyer computer. Further, in some aspects, an exchange may include a direct sale (e.g., an exchange of the item for cash or its equivalent) or a trade (e.g., an exchange of the item, whether new or used, in full or partial satisfaction for another new or used item).

Additionally, in some examples, the platform may include inventory aggregation services, inventory and/or item listing services, messaging services, information exchanges, trusted dealer group services, item settlement services, item and/or dealer review services, backstopping services (e.g., guaranteed prices), and/or item exchange services in the form of offer, counter-offer, and/or price negotiation messaging. Further, by providing market information, retail pricing, preferred pricing, price backstopping, want ads, and the like, the platform may leverage dealer relationships to facilitate the buying and/or selling of items.

As an overview, items may be any products or services that may be sold or exchanged, for example, and without limitation, vehicles, computer products, firearms, articles of clothing, jewelry, consumer electronics, yard appliances, construction machines and equipment, aircraft, boats, office equipment, furniture, manufacturing equipment, packaging equipment, kitchen equipment, appliances, combinations of the foregoing, or the like, or related products and components. While many of the embodiments of this Detailed Description are described in terms of vehicles, those of skill in the art will understand that the disclosure is not so-limited, and other products, as described herein, could be substituted for vehicles.

In some examples, and as noted above, a dealer-to-dealer social marketplace platform may facilitate the sales and/or exchanges of vehicles between dealers. For example, the platform may aggregate all, or a subset of all, vehicles found in inventory at every dealer, or a subset of every dealer, within a geographic region (e.g., within various cities, counties, states/territories/provinces, the United States, or one or more other countries), a set of geographic regions, a dealer franchise, a dealer network, a group of friends, the world, etc. The vehicles and/or inventories may be received from the dealers, from dealership management systems (DMSs), or from one or more third-party services that store, collect, or otherwise manage dealer inventories. Additionally, buyers may form groups, networks, or other organizational methods for grouping dealers that the buyer knows, trusts, has worked with before, or with whom the buyer is otherwise affiliated. Thus, in some examples, a first dealer (e.g., a buyer) may create a group of trusted dealers to interact with (e.g., a second dealer whom the first dealer knows and trusts and/or a third or more dealers, whom the first dealer has worked with before). The first dealer may be able to rate or review the dealers within the group, view inventories of the dealers within the group, and add or remove dealers from the group, as well as send messages, post comments, provide purchase/exchange offers to, and/or receive purchase/exchange counter-offers from, dealers within the group.

In some examples, the platform may provide settlement services such as, but not limited to, title services, shipping services, arbitration services, financing services, payment transfer services, and the like, to the dealers (e.g., the buyer) once a purchase/exchange agreement occurs. Additionally, the platform may provide functionality for completing the purchase/exchange. However, in some examples, the platform may facilitate communication between the trading parties and may not actually be involved in the transaction between the dealers. In this way, the platform may allow the dealers to communicate and/or consummate transactions outside of the platform. However, in this case, the platform may request that the dealers provide transaction information to the platform once the transaction is complete. That way, the platform may be able to update the inventory record to indicate that a vehicle has moved from one dealer's inventory to another's.

As noted above, in some examples, dealers using the platform may rate and/or review other dealers. Additionally, dealers may rate and/or review groups they have created and/or groups of which they are members. However, in some examples, the platform may generate a score or rating for the dealers and/or groups instead of, or in addition to, the user-provided ratings. For example, a dealer or group rating may be based on satisfaction of other dealers (e.g., the user-provided ratings), a number of transactions completed by the dealer or group, a number of groups within which a dealer is a member, a number of links provided by a dealer or group, or a number of links followed by a dealer or a group.

Additionally, in some examples, dealers may be able to place want-ads, set preferences, place advertisements, and/or review advertisements. Further, dealers may be able to set notifications and/or create comments which only they can view or which may be visible to only selected and/or preset other users. For example, a dealer may be able to view a vehicle in a particular dealer's or group's inventory and then generate a comment about the vehicle, the dealer, or the group that only that dealer can view. The comment may be presented by the platform in such a way that it looks like a note on a desk, or the like, displayed over, adjacent, or near the vehicle, dealer, or group associated with the comment.

In some aspects, the platform may receive or determine wholesale, retail, and/or other values for each vehicle in the aggregated record. In some examples, a wholesale and/or retail value may be provided by the seller, a DMS service, a third-party vehicle valuation service, or it may be determined by the platform. For example, the value may be based on the condition of the vehicle, the year, the make and/or model of the vehicle, and/or market conditions, such as real-time market conditions, related to similar vehicles. By way of example and without limitation, real-time market conditions may include conditions that are determined based on real-time, or near real-time, data. That is, data may be updated continuously over a period of time such as, but not limited to, every second, every minute, every hour, every day, every week, etc., or any appropriate interval based on the context. For example, and as those of skill in the art will understand, different contexts may create different understandings of real-time (e.g., in the new and/or used automobile market, real-time market conditions may imply market conditions that change throughout a day or even a week). In other aspects, however, the value may be determined, like a listing price, by the seller.

In some examples, item sellers may be item owners who wish to sell or exchange their items, or those with the authority to sell or exchange the items for the owners. Additionally, item buyers may be those people or entities that receive items, new or used, in exchange for either money (or its equivalent) or other items. Generally, but not always, the item buyer may intend, or attempt, to resell the item that was received.

This brief introduction, including section titles and corresponding summaries, is provided for the reader's convenience and is not intended to limit the scope of the claims, nor the proceeding sections. Furthermore, the techniques described above and below may be implemented in a number of ways and in a number of contexts. Several example implementations and contexts are provided with reference to the following figures, as described below in more detail. However, the following implementations and contexts are but a few of many.

### Illustrative Architecture

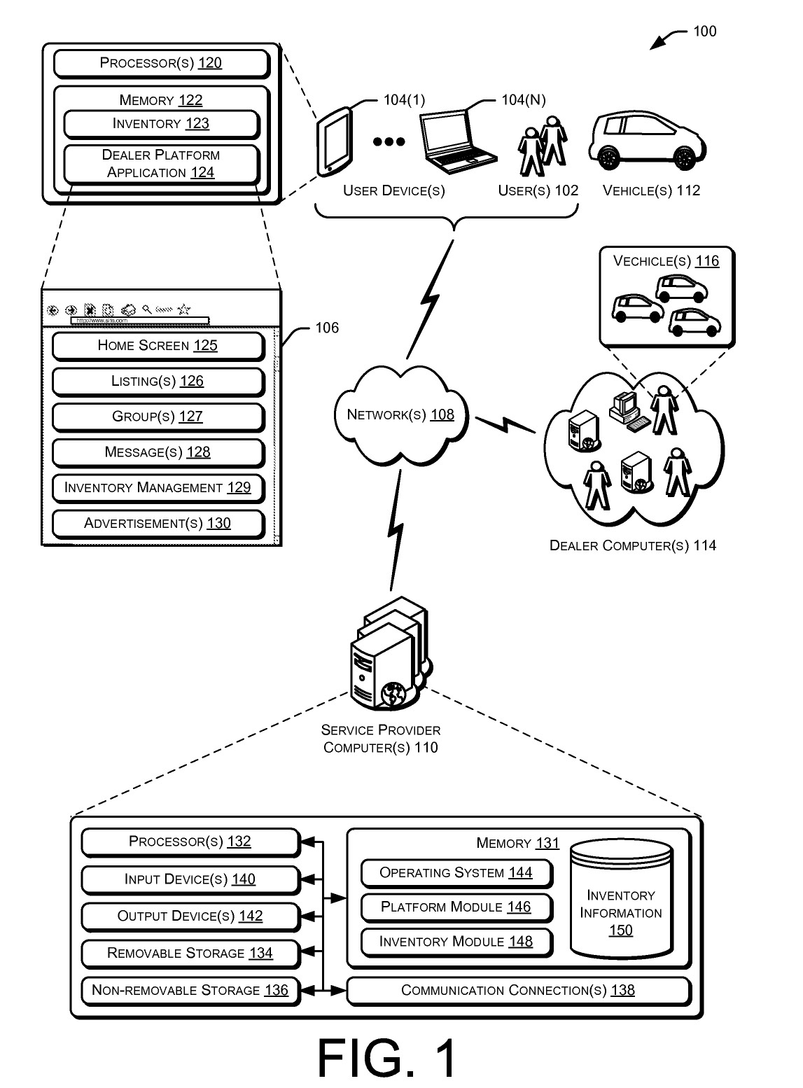

FIG. 1 depicts an illustrative architecture 100 in which techniques for a dealer-to-dealer social marketplace platform may be implemented. In architecture 100, one or more users 102 may utilize computing devices 104(1), . . . , 104(N) to access a client application interface (or website) 106 that may be provided by, created by, or otherwise associated with a service provider via one or more networks 108. In some instances, the computing devices (collectively 104) may be configured to present or otherwise display the client application interface 106 to the one or more users 102. The networks 108 may include any one or a combination of multiple different types of networks, such as cable networks, the Internet, wireless networks, and other private and/or public networks. While the illustrated example represents users 102 (e.g., a dealer) accessing the client application interface 106 over the networks 108, the described techniques may equally apply in instances where the users 102 interact with a service provider via a personal computer, over the phone, via a kiosk, or in any other manner. It is also noted that the described techniques may apply in other client/server arrangements (e.g., set-top boxes, etc.), as well as in non-client/server arrangements (e.g., locally stored software applications, etc.).

In some aspects, the client application interface 106 may allow the users 102 to access, receive from, transmit to, or otherwise interact with the service provider via one or more service provider computers 110. In some examples, the client application interface 106 may also allow users to receive, from the service provider computers 110 over the networks 108, information associated with one or more vehicles 112 in an inventory of a user 102 including, but not limited to, the make, the model, the color, the mileage, the vehicle identification number (VIN), condition, trim, etc. Through the client application interface 106, the user 102 may provide information associated with a vehicle 112 that the user 102 would like to sell or exchange. Additionally, through the client application interface 106, the user 102 may also provide information associated with a vehicle 112 that resides on the user's 102 lot, regardless of whether it is currently for sale or not. Further, in some examples, information about vehicles 112 that are in a user's 102 inventory may be provided to the service provider computers 110 by third-party providers such as, but not limited to, DMSs, other inventory management systems, or other inventory data feeds. Moreover, the user 102 may provide information associated with a vehicle 112 that the user 102 would like to sell or exchange by scanning the VIN associated with the vehicle 112 with a mobile VIN scanner application associated with the user devices 104.

The service provider computers 110 may be any type of computing devices such as, but not limited to, mobile, desktop, and/or cloud computing devices, such as servers. In some examples, the service provider computers 110 may be in communication with the user devices 104 via the networks 108, or via other network connections. The service provider computers 110 may include one or more servers, perhaps arranged in a cluster, as a server farm, or as individual servers not associated with one another. These servers may be configured to host a website viewable via the client application interface 106 or any other Web browser accessible by a user 102 such as, but not limited to, one or more of the user devices 104.

The architecture 100 may also include one or more vehicle dealers operating one or more dealer computing devices 114 and/or selling (or trading) one or more vehicles 116, such as at a used and/or new car lot. The dealer computing devices 114 may also be any type of computing devices, such as but not limited to, mobile, desktop, and/or cloud computing devices, such as servers. In some examples, the dealer computers 114 may be in communication with the service provider computers 110 and/or the user devices 104 via the networks 108, or via other network connections. In some examples, the dealer computer 114 may be one or more user devices 104. As such, it will be understood by those of ordinary skill in the art that the user 102 may be a dealer 114. The dealer computers 114 may include one or more servers, perhaps arranged in a cluster, as a server farm, or as individual servers not associated with one another. These servers may be configured to provide information associated with the vehicles 116 to the service provider computers 110 and/or to one or more third-party inventory aggregators such as, but not limited to, a DMS or other inventory management service provider.

The user devices 104 may be any type of computing devices including, but not limited to, desktop personal computers (PCs), laptop PCs, mobile phones, smart phones, personal digital assistants (PDAs), tablets PCs, game consoles, set-top boxes, wearable computers, e-readers, web-enabled TVs, cloud-enabled devices and work stations, and the like. In some instances and as illustrated, each user device 104 may be equipped with one or more processors 120 and memory 122 to store applications and data, such as inventory 123 and/or a dealer platform application 124 that may display the client application interface 106 and/or enable access to the Web site 106 stored on the service provider computers 110, or elsewhere. Additionally, each user device 104 may include scanning functionality, such as a bar code reader application or the like.

In some aspects, the client application interface 106 may display a home screen 125 for interacting with the dealer platform application 124. Additionally, the interface 106 may provide functionality for vehicle listings 126, dealer groups 127, and/or user messages 128. Further, the interface 106 may provide inventory management 129 capabilities and/or the ability for users 102 to provide, rate, and/or review advertisements 130. In some aspects, the home screen 125 may provide links and/or images for allowing users 102 to interact with and/or operate the dealer platform application 124. The vehicle listings 126 functionality may provide users 102 with the ability to view, rank, and/or filter vehicle listings. For example, a user 102 may use the listings 126 functionality to request to view a listing of a particular type of vehicle in an inventory within a certain price range, distance from the user 102, and/or in an inventory of a dealer within a particular group. The groups 127 functionality may provide a user 102 with the ability to create groups of one or more dealers 114. For example, users 102 may create groups of trusted dealers, groups of dealers within a certain geographic region, groups of dealers that sell/trade a particular brand of vehicle, etc.

The messages 128 functionality may provide a user 102 with the ability to post or send messages to other users 102 (e.g., dealers 114), group members, or a bulletin board. In some examples, a user 102 may be able to send an email, a text message, a voice message, an instant message (IM), or any other type of message that may be sent to another user device 104 or a dealer computer 114. The messages 128 may provide functionality for general communication between users 102 and/or dealers 114, for making offers and/or counter-offers, and/or for leaving reviews and/or ratings of other users 102, dealers 114, groups, etc. In some examples, the messages 128 may be provided as pop-up messages. The inventory management tool 129 may, in some examples, allow a user 102 and/or a dealer 114 to update, view, and/or provide an inventory of vehicles available for purchase. Further, the advertisements tool 130 may be configured to allow a user to provide and/or create an advertisement to be displayed as a banner or as a pop-up advertisement on a home screen 125, on a listing screen 126, or on any other page of the interface 106. In some examples, an offer message may be sent to a dealer computer 114 and accepted by the seller. The architecture 100 may then be configured to facilitate the consummation of the sale or trade. Alternatively, the user 102 and seller may consummate the transaction on their own and notify the architecture 100 via the interface 106 of the transaction completion. In some instances, the inventory 123 of the user 102 may then be updated with the new vehicle. Similarly, a push to the DMS of the seller may be able to update the inventory of the seller as well.

In some examples, the listings screen 126 may include a wholesale and/or retail price next to, or otherwise adjacent to, each vehicle listed. The wholesale and/or retail value may be determined by the service provider computers 110 and may be based at least in part on market information, including, but not limited to, location, current exchange values, the demand for the particular vehicle 112 at the time of the listing, etc., and/or on condition, mileage, age, make, features/components, and/or model information associated with the vehicle 112. However, in some examples, the retail value may be predetermined and/or set by the seller, may be understood from the seller's asking price, and/or may also be received from a DMS associated with the seller. Additionally, in examples of other items (e.g., used digital cameras) that may be listed via the client application interface 106, market information may be determined based at least in part on the location of the camera, exchange values in particular locations, demand for the particular camera, condition, number of megapixels, brand, model, and/or other information associated with the camera. Further, one of skill in the art will understand that other factors may be involved for other items that may be listed through the services described herein, and that any type of item may be listed utilizing the disclosed services.

In some aspects, one or more servers, perhaps arranged in a cluster or as a server farm, may host the service provider 110. Other server architectures may also be used to host the service provider 110. The service provider computers 110 are capable of handling requests from many users 102 and serving, in response, various listings, messages, advertisements, and/or user interfaces that can be rendered at user devices 104.

In one illustrative configuration, the service provider computer 110 comprises at least a memory 131 and one or more processing units (or processor(s)) 132. The processor(s) 132 may be implemented as appropriate in hardware, software, firmware, or combinations thereof. Software or firmware implementations of the processor(s) 132 may include computer-executable or machine-executable instructions written in any suitable programming language to perform the various functions described.

Memory 131 may store program instructions that are loadable and executable on the processor(s) 132, as well as data generated during the execution of these programs. Depending on the configuration and type of service provider computer 110, memory 131 may be volatile (such as random access memory (RAM)) and/or non-volatile (such as read-only memory (ROM), flash memory, etc.). The service provider computer 110 or server may also include additional removable storage 134 and/or non-removable storage 136 including, but not limited to, magnetic storage, optical disks, and/or tape storage. The disk drives and their associated computer-readable media may provide non-volatile storage of computer-readable instructions, data structures, program modules, and other data for the computing devices. In some implementations, the memory 131 may include multiple different types of memory, such as static random access memory (SRAM), dynamic random access memory (DRAM), or ROM.

The memory 131, the removable storage 134, and the non-removable storage 136 are all examples of computer-readable storage media. For example, computer-readable storage media may include volatile and non-volatile, removable and non-removable media implemented in any method or technology for storage of information such as computer-readable instructions, data structures, program modules, or other data. Memory 131, removable storage 134, and non-removable storage 136 are all examples of computer storage media. Additional types of computer storage media that may be present include, but are not limited to, programmable random access memory (PRAM), SRAM, DRAM, RAM, ROM, electrically erasable programmable read-only memory (EEPROM), flash memory or other memory technology, compact disc read-only memory (CD-ROM), digital versatile discs (DVD) or other optical storage, magnetic cassettes, magnetic tape, magnetic disk storage or other magnetic storage devices, or any other medium which can be used to store the desired information and which can be accessed by the service provider computer 110 or other computing devices. Combinations of the any of the above should also be included within the scope of computer-readable media.

Alternatively, computer-readable communication media may include computer-readable instructions, program modules, or other data transmitted within a data signal, such as a carrier wave, or other transmission. However, as used herein, computer-readable storage media does not include computer-readable communication media.

The service provider computer 110 may also contain communication connection(s) 138 that allow the service provider computer 110 to communicate with a stored database, another computing device or server, user terminals, and/or other devices on a network. The service provider computer 110 may also include input device(s) 140 such as a keyboard, mouse, pen, voice input device, touch input device, etc., and output device(s) 142, such as a display, speakers, printers, etc.

Turning to the contents of the memory 131 in more detail, the memory 131 may include an operating system 144 and one or more application programs or services for implementing the features disclosed herein including a platform module 146, an inventory module 148, and/or an inventory information datastore 150. The platform module 146 may be configured to receive, store, create, and/or determine a vehicle listings 126 associated with one or more vehicles 112 of users 102 and/or vehicles 116 of the dealers 114. Additionally, the platform module 146 may facilitate group formation and organization, dealer messaging, and/or advertisements. The inventory module 148 may be configured to receive, store, and manage inventory information from licensed dealers. For example, the inventory module 148 may pull, request, scrub, mine, or otherwise collect vehicle inventory information from one or more of the dealer computers 114, the user devices 104 (e.g., inventory 123), a DMS, and/or a data feed. In some aspects, the inventory information may include a VIN number, a make, a model, a year, a condition, a color, a trim, a value, a mileage, an image, a recording, a video, a location, a seller, an inventory identifier, an amount of time the vehicle has been in a particular inventory, and/or an amount of time the vehicle has been available for exchange, trade, and/or sale. The inventory information datastore 150 may store information associated with one or more vehicles 112 or 116 that are found in one or more inventories of the users 102 and/or the dealers 114. For example, the inventory information datastore 150 may include information associated with every vehicle in a first inventory and every vehicle in a second inventory, each inventory associated with a different user 102 or the dealer 114. Further, the inventory information datastore 150 may be configured to store an index, a chart, a table, or other data structure for associating particular vehicle information with each vehicle stored in the datastore 150.

In some aspects, the platform module 146 may be configured to receive information associated with one or more vehicles in an inventory of a first dealer computer 114, or an affiliate of the first dealer. The vehicle information may be received from the first dealer computer 114, from an affiliate or associate, from a DMS, or from a third-party inventory management system or a data feed. The platform module 146 may then receive, from a user dealer (e.g., the user 102, an affiliate of the user 102, or an associate of the user 102), an indication of a relationship with the first dealer. In some aspects, the indication of a relationship may involve inclusion in a group of dealers. The group may be defined by the user dealer or may be based on the vehicles' location, type, make, model, color, etc. (in other words, certain groups may be system generated). Alternatively, or in addition, the platform module 146 may be configured to determine an aggregated score for the first dealer. That is, in some cases, the platform module 146 may determine an aggregated score for a dealer based on a combination of a dealer rating, a vehicle rating, a transaction rating, and/or an activity score. Further, in some aspects, the aggregated score may be based on a combination of a number of conducted transactions, a number of positive comments provided/received, a number of hyperlinks provided, a number of hyperlinks visited, a number of groups created, a number of groups included in, and/or a value provided to the group or system.

Further, in some aspects, the platform module 146 may receive, from the user dealer, a request to view the information associated with the one or more vehicles. The platform module 146 may then determine whether the user dealer is a member of the system or a non-member viewer. In some examples, when the user dealer is a member, the platform module 146 may then determine a rating of the first dealer or a level of trust between the first dealer and the user dealer based on the indication of the relationship or the aggregated score. Finally, the platform module 146 may provide, to the user dealer, the information associated with the one or more vehicles in the inventory of the first dealer based on the determined level of trust or the determined rating. However, in some examples, instead of the vehicle information being obtained or otherwise coming from just a first dealer, the platform module 146 may provide the above services utilizing vehicles and/or vehicle information aggregated by the inventory module 148 from multiple dealers. Alternatively, if the user dealer is not a member, the platform module 146 may display a more limited set of vehicle information. For example, the platform module 146 may only show a vehicle picture or a vehicle price to non-members, while the platform module 146 may display the dealer (e.g., the seller) of the vehicle, as well as other vehicle information and/or functionality for communicating with the seller.

In some examples, the platform module 146 may also be configured to determine when the first dealer is a member of the system and appropriately provide additional information to the user dealer based on this determination. For example, the user dealer may only see portions of vehicle information when the information is associated with a non-member. However, in some examples, the user dealer may be provided with additional non-member vehicle information after providing a membership invitation to the non-member, after the non-member accepts a membership invitation, and/or after the non-member joins. For example, a list of vehicles matching a search query may be provided to the user dealer. In some examples, all vehicle information (including dealer information) may be provided in the list next to vehicles associated with member inventories while only a limited amount of vehicle information may be provided next to vehicles associated with non-member inventories. In order to view the dealer of the vehicle, the location of the vehicle, etc., the user dealer may be prompted to invite the dealer to join. Once the invitation is sent or accepted, more vehicle information associated with the non-member dealer may be provided to the user dealer.

As noted above, in some aspects, the platform module 146 may receive inventory information from the dealer computers 114, from the user devices 104, or from a DMS or data feed. However, in other examples, the platform module 146 may receive inventory information from a retail vehicle exchange service, a wholesale vehicle exchange service, a commercial vehicle exchange service, a financial institution, or a vehicle listing service. Additionally, a price or value of the vehicle may be received with the information, stored, and/or provided to a user 102. Thus, the price and/or value may depend on the type of service from which the information was received. For example, if the inventory information is received from a retail exchange service, the price and/or value may be a retail value assigned to the vehicle. However, in other examples, the price and/or value of the vehicle may be independent of the information source, determined by the platform module 146 based on market information for similar vehicles, based on a value provided by a third-party, based on a wholesale value, based on a range of values associated with a relationship between the user and the dealer (e.g., when the dealer is in a user-created group), and/or based on a determined level of trust (e.g., when the dealer is trusted by the user 102).

In certain embodiments, the price and/or value of the vehicle may not be provided. In such instances, the user 102 may request one or more quotes or offers for the vehicle over the platform. In this manner, other users or dealers associated with the platform may provide offers or quotes for the vehicle. Similarly, the user may provide offers or quotes for other vehicles on the platform. For example, a user may scan the VIN of a vehicle, which may in turn provide the vehicle information to the platform. The user may then request quotes or offers from other users of the platform for the vehicle. In this manner, in some examples, the platform module 146 may be configured to provide functionality for users 102 to quote and/or provide offers to other users (e.g., dealers) for vehicles.

In some instances, the platform module 146 may provide functionality to allow a user 102 to create groups, huddles, networks, or other organizational structures for associating one or more dealers together. For example, a user 102 may create a trusted group and include one or more trusted dealers in the group. Additionally, a user 102 may create a group of dealers within a geographic region, a group of dealers that sell a particular make or model, a group of dealers that are part of a buying group, etc. In some examples, a user interface may be provided to the user 102 to create groups and/or assign dealers (e.g., other users 102) to groups. In some examples, when a list of vehicles in inventory is created for a user 102, generally, in response to an inventory query, the platform module 146 may present the group name, label, or indicator that may signify the group with which this particular dealer is affiliated. The name, label, or indicator may be presented next to, alongside of, or adjacent to the vehicle information. Additionally, once a group is created, and members are assigned to the group, the platform module 146 may receive, from the user 102, attributes for the group. In some aspects, the attributes may include a trust level, a user-generated rating, a group score, an aggregated score, and/or an activity score. Further, this score may be presented as an image, icon, moving image, moving icon, or the like. For example, a dynamic gas meter may be displayed next to a vehicle or the vehicle information to indicate the rating, score, trust level, etc. (e.g., when the needle is higher on the meter, the rating and/or score will be higher and/or different colors may indicate lower or higher scores, levels, and/or ratings. Further, dealers 114 may be able to provide group rates that are specific to certain groups. For example, a particular car may be listed by the dealer 114 at a first price for a trusted group and at a higher price for a different group.

In some examples, the platform module 146 may be configured to provide functionality for users 102 to rate and/or review other users (e.g., dealers). Additionally, key words may be mined from the reviews to generate more quantitative ratings and/or scores. This user rating may be a part, in some examples, of the aggregated score mentioned above. For example, an aggregated score (or a “thumb score” signified by a “thumb” icon) may be generated based at least in part on the user rating. For example, if a dealer gets a “thumbs up” rating from a user 102, this may increase its “thumb score” (i.e., aggregated score), while a “thumbs down” rating may decrease its “thumb score.” Other factors that may be included in a “thumb score” include, but are not limited to, vehicle ratings associated with the dealer, transaction ratings (e.g., ratings and/or reviews directed at a completed or attempted transaction such as, but not limited to, selling or trading a vehicle), activity scores (e.g., how much activity occurs on the dealer's account or behalf), a number of transactions conducted or completed, a number of positive or negative comments provided or received, a number of hyperlinks provided, a number of hyperlinks visited, a number of groups created, a number of groups included in the platform module 146, and/or a value provided to the group. Additionally, in some aspects, the thumb score may be provided or presented next to the vehicle information via the interface 106.

Additionally, a user 102 may initiate, provide, or request that messages be transmitted to other members. In some examples, messages may only be sent to members; however, in other examples, non-members may receive messages either with limited functionality or after an invitation to join is sent or accepted. In some examples, an interface such as, but not limited to, messages 128 of interface 106 may be configured to facilitate preparing and/or transmitting, to a user 102, an email, a text message, an instant message, a voice message, a video message, a telephone call, a video call, or any other source or method of communication. By way of example, a message may include an offer price, a counter-offer price, a request for settlement, and/or a question about the vehicle. Further, in some examples, a user 102 may create a note or other comment thread that only the user 102 can review.

As noted above, the inventory module 148 may aggregate information associated with multiple vehicles from multiple inventories. In some examples, a user 102 may then enter a search query into a search field of the platform module 146 to request a list of vehicles from the aggregated information that matches the search query. In response to the search request, the platform module 146 may conduct a search of the aggregated information and return a list of vehicles with associated vehicle information, icons (e.g., a “thumb score,” a meter, a group indicator, etc.), and/or vehicle values. Further, the platform module 146 may also be configured to receive a filter and/or a ranking parameter for filtering and/or ranking the search results. For example, a filter parameter or a ranking parameter may include a network, a group, a dealer identifier, an associate identifier, a trust level, a relationship, a vehicle type, a vehicle make, a vehicle model, a vehicle color, a vehicle mileage, and/or a vehicle condition. That is, the search results may be refined, filtered, and/or ranked based on any one or a combination of these parameters. Additionally, in some examples, the filtering and/or ranking parameters may be weighted such that some parameters have more influence on the filtering and/or ranking.

As noted above, a list of search results may include an indication of the group that the vehicle belongs to (if any). In some aspects, next to or associated with the search results, the platform module 146 may also present an indication of how long the vehicle has been in inventory. The indication may be a number (e.g., a number of days) or it may be an icon that represents time in some way such as, but not limited to, an icon, a color, an image, a video, a chart, or a graph. Alternatively, or in addition, the indication of how long the vehicle has been in inventory may, by way of example, only be displayed once the length of time has passed beyond a predefined time. Additionally, each predefined time period may be defined by the members of a group. Further, in some examples, proxy bids and/or offers may be placed on vehicles by users 102 even when not logged in. In some aspects, the proxy offer may be placed on vehicles that drop below a certain price, are listed longer than the predetermined time, or are listed for longer than some other predefined time.

In some examples, the platform module 146 may also be configured to receive and/or provide want-ads to members. That is, a user 102 who is in the market to purchase a vehicle from another dealer 114 may create a want-ad describing the type of vehicle the user 102 is looking for. This want-ad may then be placed on the interface of other users 102 and/or dealers 114 when they access the platform. The want-ads may be transmitted via email, text message, bulletin board post, pop-up message, or any combination thereof. Additionally, the platform module 146 may be configured to receive preferences from the users 102. For example, a user 102 may set preferences including those directed to preferred dealers, preferred groups of dealers, preferred vehicles, preferred vehicle types, preferred communication settings, preferred viewing settings, and/or preferred settlement settings. Further, in some examples, the platform module 146 may be configured to provide a guarantee price to a buyer. The guarantee price may be calculated by the platform module 146 based on market information or it may be provided by a third-party service provider. In some examples, the service provider 110 may guarantee, underwrite, or otherwise insure the purchase between the user 102 and a dealer 114 selling a vehicle.

In some examples, the platform module 146 may also be configured to receive third-party advertisements from sellers, dealers, service providers, or the like. For example, a third-party transportation service may provide advertisements to vehicle buyers and sellers in the form of contextual, pop-up, banner, text, and/or rich media advertisements. Additionally, the providers of the third-party advertisements may set preferences and/or request that the provided advertisements be placed and/or viewed throughout the interface 106 based on the service provided, the location of the vehicles being viewed, the types of the vehicles being viewed, preferred provider networks, etc. For example, a German body shop may select, prefer, request, or even pay a premium to have an advertisement placed next to a list of German vehicles that are for sale. In some aspects, dealers may be able to set preferences regarding which third-party service advertisements they prefer to be presented near, on the same page, or at the same time as vehicles they are offering for sale. Additionally, in some aspects, users 102 and/or dealers may be able to rate the third-party service providers using a rating system that may include “thumbs-up,” comments, stars, etc. For example, next to each third-party advertisement, one or more comments and/or a star, “thumb,” or other rating scale may be visible. Further, in some examples, a portion of the advertisement may include a button, icon, or other selector for viewing the ratings and/or comments provided by users 102 and/or dealers.

Further, in some examples, the platform module 146 may also be configured to provide one or more vehicle tickers such as, but not limited to, a scrolling “new car” ticker, a scrolling “hot car” ticker, combinations of the foregoing, or the like. For example, a streaming and/or scrolling ticker may be placed on the top, bottom, or other portion of the interface 106 to display vehicles and/or hyperlinks to detail and/or listing pages of vehicles that have recently been added to inventory at one or more dealer's lots. As mentioned, the ticker may include hyperlinks to detail and/or listing pages; however, the ticker may also include images, prices, and/or other information. Additionally, in some examples, a “hot car” ticker may be provided that displays hyperlinks, images, information, prices, etc. of vehicles that been determined or otherwise indicated as being popular, highly sought after, or otherwise in demand. For example, vehicles that have been purchased, traded, and/or viewed a number of times above a predefined threshold may be displayed in the “hot cars” ticker. Further, in some examples, the “new car” and “hot car” tickers may be combined to a single ticker. In this case, some identifier may be applied to the ticker to indicate which vehicles are “new” and which vehicles are “hot.” For example, “hot” cars may be a different color or may be identified with flames around or near the hyperlink, image, text, etc. In some aspects, the users 102 may be able set preferences regarding what vehicles and/or information should be provided (if at all) in the one or more tickers. For example, the users 102 may turn off the tickers, set the location, number, color, size, etc. of the tickers, and/or determine what vehicles should be included in the tickers. For example, a user 102 may prefer, and thus set the preferences, to have the ticker(s) display “new” and/or “hot” vehicles of a particular price, location, make, model, dealer, color, etc. Additionally, the user 102 may be able to set preferences for determining what and/or how cars are classified “new” and/or “hot.”

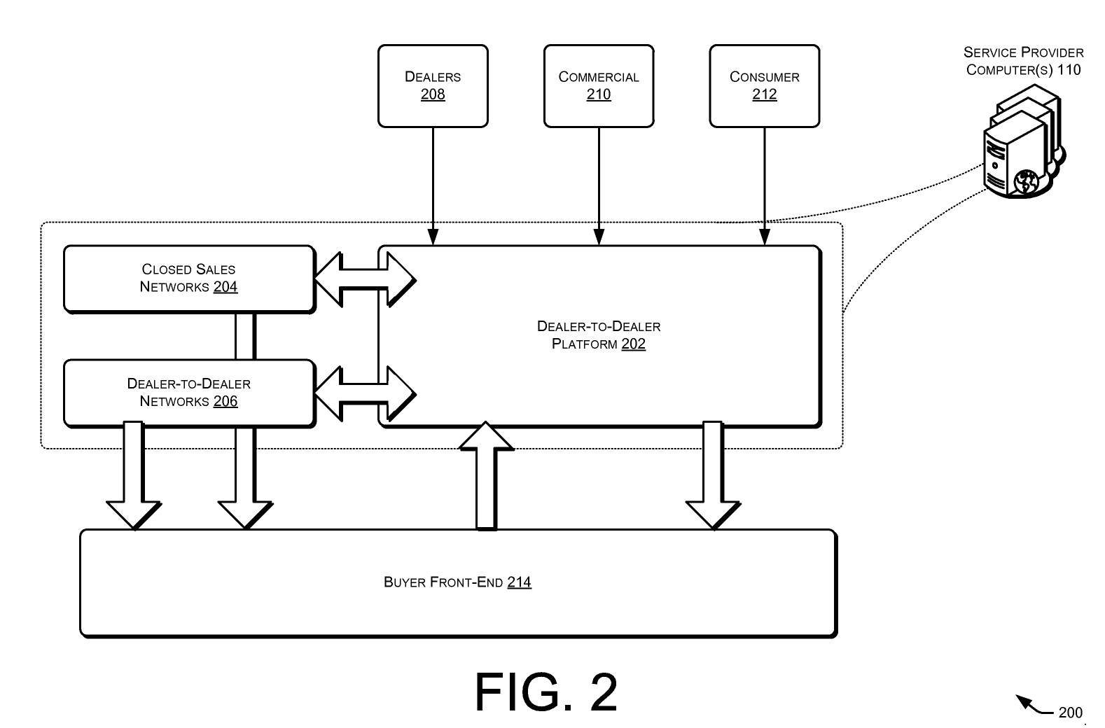

FIG. 2 depicts an illustrative architecture 200 in which additional techniques for facilitating a social marketplace platform may be implemented. In architecture 200, the service provider computer 110 is shown again and, similar to FIG. 1, may be in communication with one or more vehicle dealers with inventories in some instances.

In some examples, as seen by the short-dashed box and lines, the service provider computer 110 may be configured to implement a Web site, such as the dealer-to-dealer platform site 202 that may interact with one or more closed sales networks 204 and/or dealer-to-dealer networks 206. The dealer-to-dealer platform 202 may be configured to perform and/or facilitate the functionalities described above with respect to the platform module 146 of FIG. 1. Additionally, a closed sales network 204 may include any type of auction-style marketplace for selling and/or trading vehicles (in some instances with appropriate licensure). Additionally, a dealer-to-dealer network 206 may include buyer groups and the like.

In some examples, vehicles inventories may be provided, requested, or otherwise received by the dealer-to-dealer platform 202 by at least one of a dealer 208, a commercial service provider 210, and/or a consumer product 212. That is, and described above, vehicle inventories from multiple different sources may be aggregated by the dealer-to-dealer platform 202. Here, the platform 202 may receive inventory information from one or more dealers 208, in some examples, directly from the dealer's 208 local inventory management system. Alternatively, however, the inventory information may be received from the dealer 208 via a DMS that the dealer 208 regularly updates. Additionally, the platform 202 may also receive inventory information from one or more commercial service providers such as, but not limited to, financial institutions, rental car companies, credit card companies, and the like. Further, in some examples, the platform 202 may also receive inventory information from one or more consumer products such as, but not limited to, online vehicle marketplaces and the like.

As noted above, in some aspects, the dealer-to-dealer platform 202 may be configured to provide communication channels to dealers. For example, the platform 202 may facilitate offers, counter-offers, and general conversations about purchasing and/or trading vehicles with other dealers that are members of the service provided by the service provider computers 110. As such, the dealer-to-dealer platform 202 is shown as providing information to either (or both) of a closed sales network 204 or a dealer-to-dealer network 206 where the dealers may consummate the transactions on their own. In some examples, however, closed sales networks 204 and/or the dealer-to-dealer networks 206 may report back to the platform 202, indicating that the transaction has been completed and that inventories may be updated. Additionally, in some aspects, the users may interact with the dealer-to-dealer platform 202 via a buyer front-end 214. The buyer front-end 214 may be configured to facilitate the dealer platform application 124 and/or the platform module 146 of FIG. 1. Further, in some instances, once the transaction between the buyer and the seller is complete, the buyer front-end 214 may report back to the platform 202, indicating that the transaction has been completed and that inventories may be updated. In some examples, the buyer front-end 214 may include, but is not limited to, a vehicle exchange front-end, a DMS partner front-end, and/or third-party partner front-ends (e.g., mobile applications).

Various instructions, methods and techniques described herein may be considered in the general context of computer-executable instructions, such as program modules, executed by one or more computers or other devices. Generally, program modules include routines, programs, objects, components, data structures, etc. for performing particular tasks or implementing particular abstract data types. These program modules and the like may be executed as native code or may be downloaded and executed, such as in a virtual machine or other just-in-time compilation execution environment. Typically, the functionality of the program modules may be combined or distributed as desired in various embodiments. An implementation of these modules and techniques may be stored on some form of computer-readable storage media.

The example architectures and computing devices shown in FIGS. 1 and 2 are provided by way of example only. Numerous other operating environments, system architectures, and device configurations are possible. Accordingly, embodiments of the present disclosure should not be construed as being limited to any particular operating environment, system architecture, or device configuration.

### Illustrative Processes

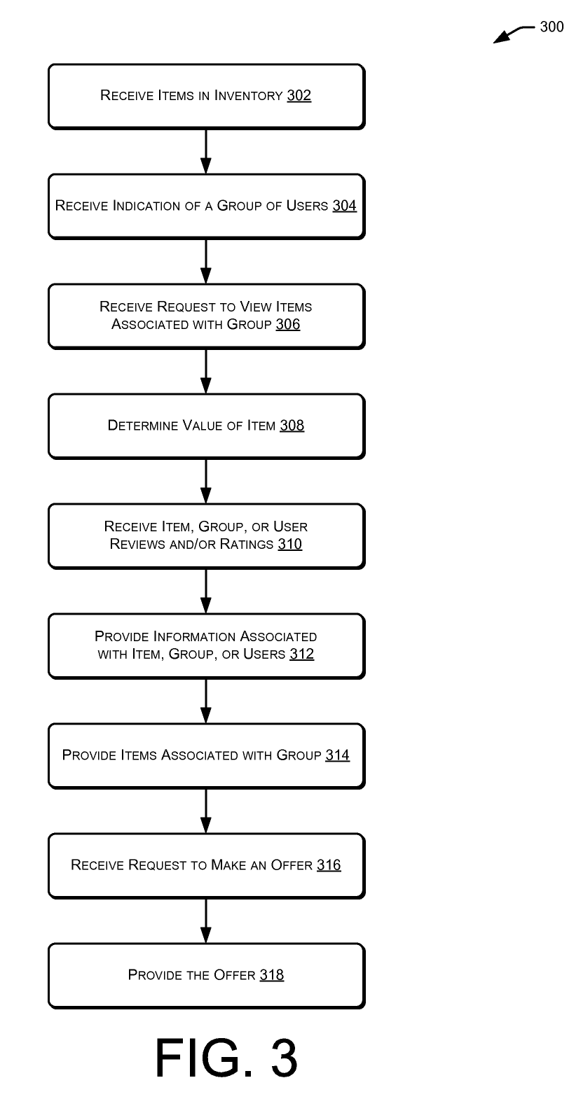

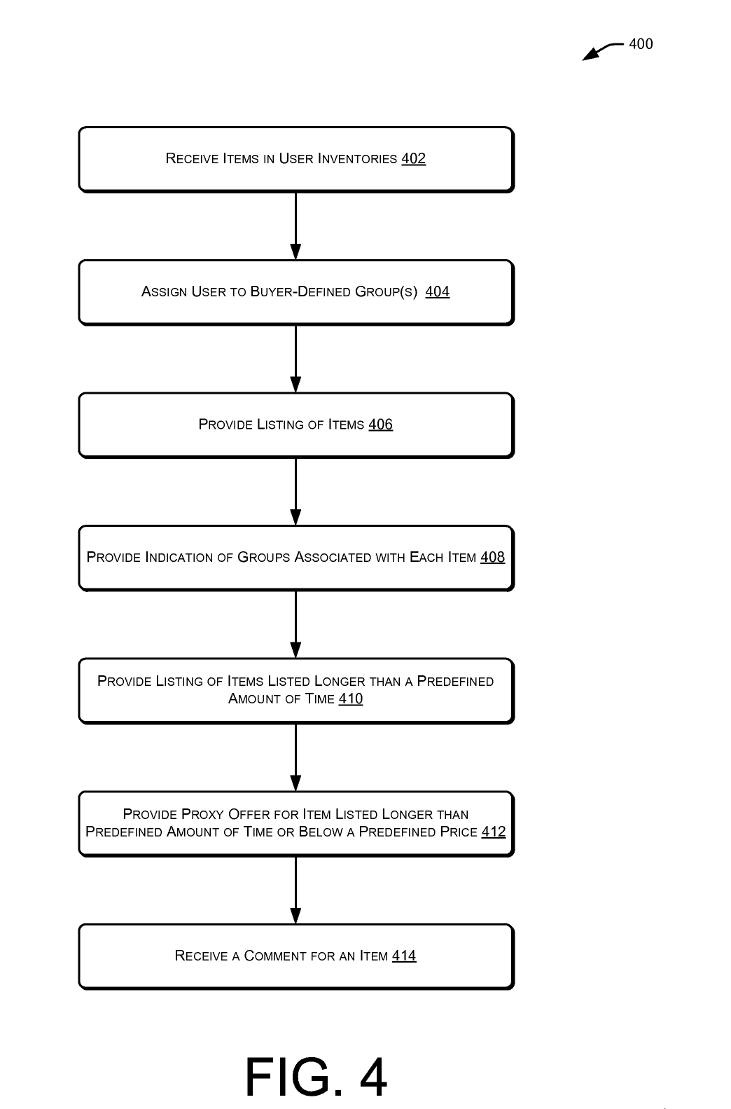

FIGS. 3 and 4 illustrate example flow diagrams showing processes 300 and 400, respectively, for providing a dealer-to-dealer social marketplace. These processes are illustrated as logical flow graphs, each operation of which represents a sequence of operations that can be implemented in hardware, software, or a combination thereof. In the context of software, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described operations can be combined in any order and/or in parallel to implement the processes.

The process 300 may, but need not, be implemented by a computing device operated by a service provider, such as the service provider computer 110. In some aspects the process 300 may begin by receiving items or item information that exists in an inventory at block 302. For example, the service provider computers 110 may receive the inventory 123 via the interface 106 implemented at the user device 104 of FIG. 1. In some examples, the items may, but need not, include vehicles, computer products, firearms, articles of clothing, consumer electronics, yard appliances, construction machines and equipment, aircraft, boats, office equipment, furniture, manufacturing equipment, packaging equipment, kitchen equipment, appliances, combinations of the foregoing, or the like, or related products and components. At block 304, the process 300 may receive an indication of a group of users. This may be received by a user such as the user 102 of FIG. 1 or by any dealer that is a member of the service provided by the service provider computer 110 of FIG. 1.

In some instances, the process 300 may then receive a request to view items associated with the group at block 306. The process 300 may also determine a value or price of the item being searched at block 308. At block 310, item, group, and/or user reviews and/or ratings may also be received by the process 300. In some examples, the request to view items, the value of the items, and/or the reviews and/or ratings may all be provided by a user who is shopping for an item such as a vehicle. Alternatively, however, the value determined at block 308 may be provided by a local processor or other computing device.

At block 312, the process may provide information associated with the item, group, or users by hosting a list, an index, a chart, or other data structure that can be displayed by the interface 106 of the user device 104. In this way, the list or other structure may be communicated via the networks 108. In some examples, the process 300 may also provide items associated with user-defined groups at block 314. This may include reordering the list, filtering out non-group items, and/or providing an indication next to each group item to indicate that the item is in an inventory of a group member. At block 316, the process 300 may receive a request to make an offer to the seller of an item. The process 300 may then end by providing the offer to the seller at block 318. As noted above, providing a message to a dealer may include text messaging, instant messaging, voice mails, video calls, etc.

FIG. 4 illustrates a flow diagram showing process 400 for providing a dealer-to-dealer social marketplace service. The process 400 may, but need not, be implemented by a computing device operated by a service provider, such as the service provider computer 110. In some aspects, the process 400 may begin by receiving items in user inventories at block 402. In some aspects, the users are members and their inventories may be readily accessible to all other members. However, in other cases, if the user is not a member, its inventory may have limited searchability and/or access by the users. At block 404, the process 400 may assign a user to one or more buyer-defined groups by utilizing the groups module 127 of the user device 104, as shown in FIG. 1.

In some aspects, the process 400 may then provide a listing of appropriate items at block 406. Further, at block 408, the process 400 may provide an indication of groups associated with each item, by placing an icon, an image, a video, a color, etc., near or adjacent to the item and/or item information in the listing provided at block 406. Additionally, in some aspects, the process 400 may also indicate which items in the listing have been listed for longer than a predefined amount of time at block 410. Further, the process 400 may provide proxy offers for items listed longer than a predefined amount of time or for items listed below a predefined price at block 412. In some aspects, the predefined time and predefined price may be set by the buyer in the settings section of the dealer platform application 124 and/or the platform module 146. The process 400 may then end by receiving a comment for an item (and possibly storing that comment for future use) at block 414.

Illustrative methods and systems for providing a social marketplace platform are described above. Some or all of these systems and methods may, but need not, be implemented at least partially by architectures such as those shown in FIGS. 1 and 2 above.

That which is claimed:

1. A system, comprising:
at least one memory that stores computer-executable instructions; and
at least one processor configured to access the at least one memory, wherein the at least one processor is configured to execute the computer-executable instructions to:
receive, from a database, information associated with one or more vehicles in an inventory of a first dealer or information associated with one or more vehicles in an inventory of a second dealer;
receive, from a computing device of a third dealer, an indication of a relationship with the first or second dealer or determine an aggregated score for the first or second dealer;
receive, from the computing device of the third dealer, a request to view the information associated with the one or more vehicles;
determine that the third dealer is a member of the system;
determine a rating of the first or second dealers, a level of trust between the first dealer and the third dealer, or a level of trust between the second dealer and the third dealer based at least in part on the indication of the relationship or the aggregated score; and
provide, to the third dealer, the information associated with the one or more vehicles in the inventory of the first or second dealers based at least in part on the determined level of trust or the determined rating.

2. The system of claim 1, wherein the at least one processor is further configured to execute the computer-executable instructions to:
determine when at least one of the first or second dealer is a member of the system;
provide, to the third dealer, an amount of the information associated with the one or more vehicles in the inventory of the first dealer greater than an amount of the information associated with the one or more vehicles in the inventory of the second dealer when the first dealer is a member of the system and the second dealer is not a member of the system;
provide, to the third dealer, an amount of the information associated with the one or more vehicles in the inventory of the second dealer greater than an amount of the information associated with the one or more vehicles in the inventory of the first dealer when the second dealer is a member of the system and the first dealer is not a member of the system; and
provide, to the third dealer, equal amounts of the information associated with the one or more vehicles in the inventory of the first dealer and the information associated with the one or more vehicles in the inventory of the second dealer when both the first and second dealers are members of the system.

3. The system of claim 2, wherein the at least one processor is further configured to execute the computer-executable instructions to:
receive, from the third dealer, a request to invite a non-member dealer to become a member of the system;
invite the non-member to become a member of the system; and
provide, to the third dealer, additional information associated with the one or more vehicles in the inventory of a non-member dealer in response to the request to invite the non-member dealer.

4. The system of claim 2, wherein the at least one processor is further configured to execute the computer-executable instructions to:
receive, from the third dealer, a request to invite a non-member dealer to become a member of the system;
invite the non-member to become a member of the system; and
provide, to the third dealer, additional information associated with the one or more vehicles in the inventory of a non-member dealer in response to acceptance, by the non-member, of the invite.

5. The system of claim 1, wherein the relationship comprises inclusion in a group of dealers, and wherein the at least one processor is further configured to execute the computer-executable instructions to:
provide, to a dealer in the group of dealers, a first level of access to the information associated with the one or more vehicles; and
provide, to a dealer not in the group, a second level of access to the information associated with the one or more vehicles, wherein the first level of access comprises more information access than the second level of access.

6. The system of claim 5, wherein the group of dealers is created or defined by the third dealer, and wherein the third dealer provides an indication of which dealers to include in the group of dealers.

7. The system of claim 5, wherein the group of dealers is created or defined by the at least one processor, and wherein the group of dealers is associated with at least one of a location, a vehicle type, a vehicle make, or a vehicle model.

8. The system of claim 1, wherein the database comprises at least one of at least one memory of a dealership management system (DMS) computing device, a retail vehicle exchange service computing device, a wholesale vehicle exchange service computing device, a commercial vehicle exchange service computing device, a financial institution computing device, or a vehicle listing service computing device.

9. The system of claim 1, wherein one or more of the first, second, or third dealers are associates that are affiliated with the first, second, or third dealers.

10. The system of claim 1, wherein the information associated with the one or more vehicles comprises at least one of a vehicle identification number (VIN), a make, a model, a year, a condition, a color, a trim, a value, a mileage, an image, a recording, a video, a location, a seller, an inventory identifier, an amount of time the one or more vehicles has been in a particular inventory, or an amount of time the one or more vehicles has been available for exchange, trade, or sale.

11. The system of claim 10, wherein the value comprises a retail value, a value determined based at least in part on market conditions, a value provided by a third party, a wholesale value, or a range of values associated with the relationship or the determined level of trust.

12. The system of claim 1, wherein the indication of the relationship comprises an assignment, by the third dealer, of the first or second dealer into one or more networks.

13. The system of claim 12, wherein the at least one processor is further configured to execute the computer-executable instructions to:
provide an interface to the third dealer for creating the one or more networks; and
receive, from the third dealer, the assignment of the first or second dealer into the one or more networks.

14. The system of claim 12, wherein the one or more networks are defined by the third dealer.

15. The system of claim 12, wherein the at least one processor is further configured to execute the computer-executable instructions to provide an indication of an assigned network for each of the provided information associated with the one or more vehicles, and wherein the provided indication is adjacent to the provided information.

16. The system of claim 12, wherein the at least one processor is further configured to execute the computer-executable instructions to receive, from the third dealer, one or more attributes for the one or more networks, wherein the one or more attributes comprise at least one of a trust level, a user-generated rating, a group score, an aggregated score, or an activity score.

17. The system of claim 1, wherein the indication of the relationship comprises a rating of the first or second dealer provided by the third dealer.

18. The system of claim 1, wherein the indication of the relationship comprises a relationship level associated with the first or second dealer provided by the third dealer.

19. The system of claim 1, wherein the aggregated score comprises a combination of at least one of a dealer rating provided by one or more users, a vehicle rating provided by one or more users, a transaction rating provided by one or more users, or an activity score.

20. The system of claim 1, wherein the aggregated score comprises a combination of at least one of a number of transactions conducted, a number of positive comments provided, a number of hyperlinks provided, a number of hyperlinks visited, a number of groups created, a number of groups included in, or a value provided to the group or the system.

21. The system of claim 1, wherein the level of trust comprises a range of trust between a trusted dealer and an untrusted dealer.

22. The system of claim 1, wherein the at least one processor is further configured to execute the computer-executable instructions to provide an interface to the third dealer that facilitates sending, to the first or second dealers, an email, a text message, an instant message, a voice message, a video message, a telephone call, or a video call.

23. The system of claim 1, wherein the at least one processor is further configured to execute the computer-executable instructions to provide an interface to the third dealer that facilitates providing, to the first or second dealers, an offer to purchase at least one of the one or more vehicles.

24. The system of claim 23, wherein the at least one processor is further configured to execute the computer-executable instructions to provide an interface to the first or second dealers that facilitates providing, to the third dealer, a counter-offer associated with the offer to purchase at least one of the one or more vehicles.

25. The system of claim 23, wherein the at least one processor is further configured to execute the computer-executable instructions to receive an indication of one or more selected settlement services selected by the third dealer and the first or second dealer agree to trade a vehicle.

26. The system of claim 1, wherein the at least one processor is further configured to execute the computer-executable instructions to receive a filter parameter for filtering the provided information associated with the one or more vehicles.

27. The system of claim 26, wherein the filter parameter comprises at least one of a network, a group, a dealer identifier, an associate identifier, a trust level, a relationship, a vehicle type, a vehicle make, a vehicle model, a vehicle color, a vehicle mileage, or a vehicle condition.

28. The system of claim 1, wherein the at least one processor is further configured to execute the computer-executable instructions to receive a rank parameter for ranking the provided information associated with the one or more vehicles.

29. The system of claim 1, wherein the rank parameter comprises at least one of a network, a group, a dealer identifier, an associate identifier, a trust level, a relationship, a vehicle type, a vehicle make, a vehicle model, a vehicle color, a vehicle mileage, or a vehicle condition.

30. The system of claim 1, wherein the at least one processor is further configured to execute the computer-executable instructions to receive, from the computing device of the third dealer, a want-ad for a particular one or more vehicles, and further to provide the want-ad to at least one of the first or second dealer.

31. The system of claim 1, wherein the at least one processor is further configured to execute the computer-executable instructions to receive preference settings from the third dealer, wherein the preference settings comprise at least one of a preferred dealer, a preferred group of dealers, a preferred vehicle, a preferred type of vehicle, a preferred communication setting, a preferred viewing setting, or a preferred settlement setting.

32. A method, comprising:
receiving, from an inventory management computing device by at least one processor coupled to at least one memory, a plurality of items in an inventory;
receiving, from a user computing device, an indication of a group of users;
receiving, from the user computing device, a request to view one or more items of the plurality of items associated with the group;
providing, to the user computing device, the one or more items of the plurality of items associated with the group;
receiving, from the user computing device, a request to make an offer to at least one user of the group of users associated with at least one of the one or more provided items; and
providing, to the at least one user of the group of users, the offer.

33. The method of claim 32, further comprising determining, for at least one of the plurality of items, a wholesale price, a retail price, a group price, or a guarantee price.

34. The method of claim 33, wherein the wholesale price is determined based at least in part on market information.

35. The method of claim 33, wherein the retail price is determined based at least in part on information received from the inventory management computing device.

36. The method of claim 33, wherein the group price is determined based at least in part on information received from a user associated with the user computing device.

37. The method of claim 33, wherein the guarantee price is determined based at least in part on information from a third-party backstopper, a guarantor, or a guarantee price service provider.

38. The method of claim 32, further comprising receiving, from the user computing device, a rating or review of one or more of the group of users or of other users not associated with the group of users.

39. The method of claim 32, further comprising receiving, from the user computing device, at least one of a rating or a review of one or more of the plurality of items or a transaction associated with one or more of the plurality of items.

40. The method of claim 32, further comprising providing market information, item information, rating information, or reviews associated with one or more of the plurality of items.

41. The method of claim 32, wherein a user comprises a dealer of items or an associate affiliated with a dealer of items.

42. The method of claim 32, wherein a user comprises an independent retailer of items not affiliated with a franchise or a group of dealers, and wherein the offer is a wholesale price offer.

43. One or more computer-readable media storing computer-executable instructions that, when executed by at least one processor, configure the at least one processor to perform operations comprising:
receiving a plurality of items from one or more different inventories;
receiving a request to include one or more of a plurality of users into one or more groups;
receiving a review or a rank of one or more of the plurality of users;
receiving a request to view one or more of the plurality of items; and
providing the one or more of the plurality of items based at least in part on at least one of the one or more groups, the review, or the rank.

44. One or more computer-readable media storing computer-executable instructions that, when executed by at least one processor, configure the at least one processor to perform operations comprising:
aggregating inventories of a plurality of item dealers into an inventory record;
providing, to members of a service, a first level of access to the inventory record;
providing, to non-members of the service, a second level of access to the inventory record; and
providing, to a first member of the predefined group associated with the service, a purchase offer in response to a request received from a second member of a predefined group associated with the service.

45. A method, comprising:
receiving, from a third-party computer, one or more items from a plurality of inventories, each inventory associated with at least one of a plurality of item sellers;
assigning at least one of the plurality of item sellers to a group defined by an item buyer;
providing, to a computer of the item buyer, a listing of the one or more items from the plurality of items;
providing an indication of the group associated with each of the one or more items from the plurality of items provided in the listing.

46. The method of claim 45, wherein the indication of the group is provided adjacent to information associated with each of the one or more items provided in the listing.

47. The method of claim 45, further comprising providing, to the computer of the item buyer, a listing of the one or more items that are listed in at least one of the plurality of inventories for longer than a predefined amount of time.

48. The method of claim 47, wherein the predefined amount of time is defined independently for each group.

49. The method of claim 47, wherein an amount of time passed, between when the item is listed in at least one of the plurality of inventories and the predefined amount of time, is represented by at least one of an icon, a color, an image, a video, a chart, or a graph.

50. The method of claim 47, further comprising providing a proxy offer, on behalf of the item buyer, for an item that is listed for longer than the predefined amount of time or for an item that is listed for longer than a second predefined amount of time.

51. The method of claim 47, further comprising providing a proxy offer, on behalf of the item buyer, for an item that is listed below a predefined price.

52. The method of claim 45, further comprising receiving, from the item buyer, a comment for at least one of the one or more items.

53. The method of claim 52, wherein the received comment is only provided to the item buyer.
